(19) United States
(12) Patent Application Publication
(10) Pub. No.: US 2009/0116454 A1
(43) Pub. Date: May 7, 2009

(54) COMMUNICATION DEVICE, COMMUNICATION SYSTEM, AND HANDOVER METHOD

(75) Inventor: Takeshi Kanazawa, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/302,264

(22) PCT Filed: May 25, 2006
(86) PCT No.: PCT/JP2006/310489

§ 371 Date: Nov. 24, 2008

(51) Int. Cl. H04W 36/24

(52) U.S. Cl. 370/332

(57) ABSTRACT

Provided is a communication device capable of reducing the network resource and the processing load of a network host. A handover destination performs unicast of packet data reporting an address of the handover destination to an upper-node device and the upper-node device reports release of connection with a communication terminal device to the handover origin. In this device, a handover control unit (104) judges whether a handover of the communication device to the local station is enabled according to the radio resource state of the local station. A message creation unit (105) creates a message containing an address of layer 2 of the local station as the handover destination, an address of layer 3 of the communication terminal device, and a unicast address for unicast to IPAG. An IPAG interface unit (106) performs unicast of the created message to the IPAG.

### TECHNICAL FIELD

The present invention relates to a communication apparatus, a communication system and a handover method using, for example, gratuitous ARP (Gratuitous Address Resolution Protocol).

### BACKGROUND ART

Network layer protocols supporting the Internet (hereinafter “IP”) are used to manage and control data that flows from the source node to the target node in the form of IP data, by connecting with networks or subnetworks making up the Internet. In order to ensure reliable delivery of IP data packets, every node is assigned one IP address that defines the location of the node on a fixed network. Generally, IP is designed to support routing of IP packets between fixed network nodes.

However, accompanying the rapid development of radio nodes, there is a growing demand for providing IP support for mobile terminals in the same way as for fixed nodes. Here, fixed nodes generally do not move. Furthermore, mobile terminals can move within, for example, the area of the subnetworks or local area network (“LAN”) segments. Furthermore, mobile terminals can also change the point of access to the subnetworks or LAN segments regularly through different network hosts. Furthermore, as is immediately understood by those skilled in the art, a compatible network host severs as a proxy for mobile terminals.

In order to ensure that data is correctly routed to a mobile terminal and maintains its continuity even if the point of access to the subnetworks or LAN and the IP address of the mobile terminal change regularly, the mobile terminal registers itself through connections with the subnetworks or LAN. This registration processing involves creating and saving registration records in the network hosts via connecting mobile terminals. That is, a network host is able to manage or support requests for move from mobile terminals by, for example, receiving IP data packets representing mobile terminals, processing the IP data packets, and transmitting the IP data packets to mobile terminals, using information including the registration records. When a mobile terminal keeps moving from one network host to another new network host, the mobile terminal carries out the process called “handover,” whereby the mobile terminal terminates its registration with the old network host and registers itself with the new network host. The process of terminating registrations involves terminating registration record from the old network host. The process of terminating mobile terminal registrations is extremely important. For example, terminating mobile terminal registrations makes it no longer necessary to consume network resources and contributes to security. On the other hand, if terminating a mobile registration fails, one or more hosts react to the mobile terminal as a proxy, which makes the routing of IP data packets inadequate and leads to unacceptable network malfunctions.

Conventionally, a technique related to management of registration records (e .g. , deletion and/or creation) within a network host is known (e.g., see Patent Document 1). The method of handover between network hosts disclosed in Patent Document 1 will be explained using FIG. 1. FIG. 1 is a schematic diagram of a communication system to illustrate the handover method.

By performing handover from H_{OLD} 11 to H_{NEW} 12, mobile terminal (MT) 10 changes the access point to a subnetwork or LAN segment 13 from H_{OLD} 11 to H_{NEW} 12. In establishment of connection 20 between H_{NEW} 12 and mobile terminal 10, H_{NEW} 12 broadcasts a gratuitous ARP message via the subnetwork or LAN segment 13 instead of mobile terminal 10. The broadcast gratuitous ARP message is received by many nodes and H_{OLD} 11 within the subnetwork or LAN segment 13. In this way, H_{NEW} 12 can report H_{OLD} 11 that mobile terminal 10 is currently connected to the subnetwork or LAN segment 13 via H_{NEW} 12, not via H_{OLD} 11. By receiving the gratuitous ARP message, H_{OLD} 11 can know that mobile terminal 10 has performed a handover to H_{NEW} 12. H_{OLD} 11 having received the gratuitous ARP message deletes all the registration records of mobile terminal 10. Here, the gratuitous ARP message is intended to report changes of the layer 3 IP address and the Ethernet layer 2 address, to other nodes in the same network. H_{OLD} 11 manages the registration records on mobile terminal 10 having the same identifier as that of mobile terminal 10 stored in a predetermined location in the gratuitous ARP message, and can the support handover to H_{NEW} 12 by receiving the gratuitous ARP message and deleting the registration records of mobile terminal 10.

Patent Document 1: National Publication of International Patent Application No. 2002-541686

### DISCLOSURE OF INVENTION

### Problems to be Solved by the Invention

However, a conventional system broadcasts a gratuitous ARP message from destination H_{NEW} 12 upon a handover and consequently creates processing load in hosts other than H_{OLD} 11 that do not require the gratuitous ARP message, posing a problem that is unacceptable from the standpoints of network resources and processing load on the network hosts.

It is therefore an object of the present invention to provide a communication apparatus, communication system and handover method that make it possible to reduce network resources and processing load in network hosts by unicasting packet data for reporting the address of the handover destination from the handover destination to an upper layer apparatus and reporting a release of the connection with communication terminal apparatus from the upper layer apparatus to the communication terminal apparatus.

### Means for Solving the Problem

The communication apparatus according to the present invention adopts a configuration including: a handover control section that decides whether or not a handover to the communication apparatus is possible, upon receiving a report that the communication apparatus has been selected as a handover destination of a communication terminal apparatus and a layer 3 address of the communication terminal apparatus from a communication apparatus of a handover source; a message creating section that, when the handover is decided possible, creates a message storing the layer 3 address of the communication terminal apparatus and a layer 2 address of the communication apparatus; and a transmitting section that unicasts the created message to an upper layer apparatus.

The communication system according to the present invention adopts a configuration including: a communication terminal apparatus that reports a measurement result of received quality; a handover source network host that determines a handover destination based on the measurement result and reports the determination and a layer 3 address of the communication terminal apparatus to the determined handover destination; a handover destination network host that, upon receiving the report, decides whether or not a handover to the communication apparatus is possible, and that, when the handover is decided possible, unicasts a message storing the layer 3 address and a layer 2 address of the communication apparatus; and an upper layer apparatus that receives the unicast message, memorizes the layer 2 address stored in the message, sends packet data addressed to the layer 3 address to a handover destination network host of the memorized layer 2 address, and commands the handover source network host of a layer 2 address deleted by the memorization to release the connection with the communication terminal apparatus.

The handover method according to the present invention includes: a handover method comprising: reporting, by a communication terminal apparatus, a measurement result of received quality; determining, by a handover source, a handover destination based on the measurement result; reporting, by the handover source, the determination and a layer 3 address of the communication terminal apparatus to the handover destination; deciding, by the handover destination having received the report, whether or not a handover to the handover destination is possible; when the handover is decided possible, unicasting, by the handover destination, a message storing a layer 3 address and a layer 2 address of the handover destination to an upper layer apparatus; receiving the message by the upper layer apparatus; newly memorizing, by the upper layer apparatus, the layer 2 address of the handover destination included in the received message; commanding, by the upper layer apparatus, the handover source of a layer 2 address deleted by the memorization, to release the connection with the communication terminal apparatus; and sending, by the upper layer apparatus, packet data directed to the layer 3 address to the handover destination of the layer 2 address.

### Advantageous Effect of the Invention

The present invention makes it possible to reduce network resources and processing load in network hosts by unicasting packet data for reporting the address of the handover destination from the handover destination to the upper layer apparatus and by reporting a release of the connection with the communication terminal apparatus from the upper layer apparatus to the handover source.

### BRIEF DESCRIPTION OF DRAWINGS

FIG. 1 shows a conventional handover method;

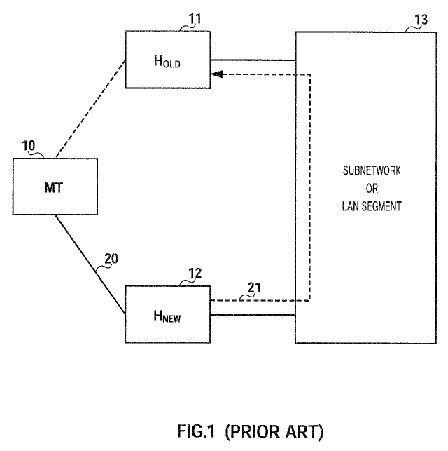

FIG. 2 is a block diagram showing a configuration of a communication apparatus according to an embodiment of the present invention;

FIG. 3 shows a network configuration according to the embodiment of the present invention;

FIG. 4 is a sequence diagram showing a handover method according to the embodiment of the present invention; and

FIG. 5 shows Ethernet data and gratuitous ARP message formats according to the embodiment of the present invention.

### BEST MODE FOR CARRYING OUT THE INVENTION

An embodiment of the present invention will be explained in detail below with reference to the accompanying drawings.

### (Embodiment)

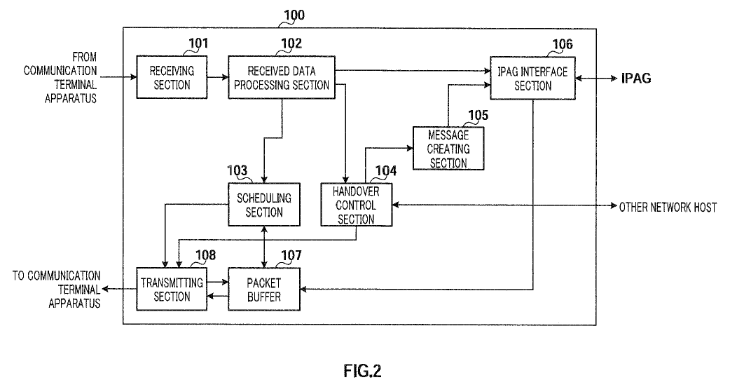

FIG. 2 is a block diagram showing the configuration of network host 100, which is a communication apparatus according to an embodiment of the present invention.

Receiving section 101 receives a signal Transmitted from a communication terminal apparatus using a radio channel, down-converts the received signal from radio frequency to a baseband frequency, and outputs the result to received data processing section 102.

Received data processing section 102 demodulates the received signal inputted from receiving section 101 and demultiplexes the received signal into the data part and the control data part. Received data processing section 102 outputs the demultiplexed data part to IP Access Gateway (hereinafter referred to as “IPAG”) interface section 106 and outputs the demultiplexed control data part to scheduling section 103 and handover control section 104.

Scheduling section 103 performs scheduling based on received quality information, which is information about the received quality in the communication terminal apparatus, included in the control data part inputted from received data processing section 102, and queue information, which is information about the amount of the data stored in packet buffer 107, inputted from packet buffer 107. For example, scheduling section 103 holds a table storing scheduling information that associates received quality such as CQI (Channel Quality Indicator) with amounts of transmission data. Scheduling section 103 selects the amount of data to transmit, with reference to the scheduling information and queue information using the received quality information such as the CQI inputted from received data processing section 102. Furthermore, scheduling section 103 controls transmitting section 108 to transmit only the selected amount of transmission data.

Handover control section 104 performs different processing depending on whether network host 100 is the handover source or the handover destination.

When network host 100 is the handover source, handover control section 104 selects a handover destination network host based on the received quality information about a plurality of network hosts included in the control data part inputted from received data processing section 102. Handover control section 104 then reports the fact of having been selected as the handover destination and the layer 3 address of the communication terminal apparatus included in the control data part to the remote network host of the handover destination. Furthermore, handover control section 104 transmits or receives various types of information, to allow a handover with the remote network host of the handover destination.

When network host 100 is the handover destination, handover control section 104 recognizes that its network host has been selected as the handover destination, by receiving from the remote network host of the handover source a report that its network host has been selected as the handover destination. Handover control section 104 decides whether or not a handover of the communication terminal apparatus to its network host is possible, based on the conditions of radio resources of the network host, and, when a handover is possible, outputs layer 3 address information, which is information about the layer 3 address of the communication terminal apparatus reported form the remote network host of the handover source, to message creating section 105. Furthermore, handover control section 104 transmits or receives various kinds of information so as to perform a handover to the remote network host of the handover source.

When network host 100 is the handover destination, message creating section 105 creates a message storing the layer 2 address of network host 100, the layer 3 address of the layer 3 address information inputted from handover control section 104 and a unicast address to be unicast to the IPAG. Message creating section 105 then outputs the created message to IPAG interface section 106. Here, the message generated by message creating section 105 is, for example, a gratuitous ARP message. Details of the message created will be described later.

IPAG interface section 106 is connected to the IPAG via a cable and sends the data part inputted from received data processing section 102, to the IPAG. Furthermore, IPAG interface section 106 outputs the packet data directed to the layer 3 address received from the IPAG, that is, directed to the communication terminal apparatus having performed a handover to network host 100, to packet buffer 107. Furthermore, IPAG interface section 106 sends the message inputted from message creating section 105 to the IPAG.

Packet buffer 107 outputs the queue information to scheduling section 103. Furthermore, packet buffer 107 stores the packet data inputted from IPAG interface section 106 on a temporary basis. Packet buffer 107 then outputs packet data, in the amount of data specified by transmitting section 108, to transmitting section 108, at predetermined timing.

Transmitting section 108 commands packet buffer 107 to output data in the amount of data specified by scheduling section 103, and sends packet data of the specified amount, inputted from packet buffer 107, using radio signals. Furthermore, transmitting section 108 sends the message commanding the handover, inputted from handover control section 104, using a radio signal.

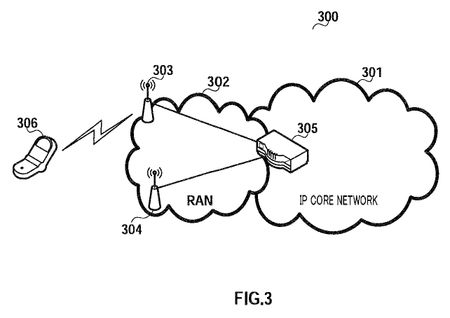

FIG. 3 shows a configuration of network 300 according to the present embodiment. Network 300 is made up of IP-based IP core network 301 and radio access network (RAN) 302. Network hosts 303 and 304 are located on RAN 302 and are connected to IPAG 305 via a cable. IPAG 305 is located within IP core network 301 and functions as a gateway for external networks. Communication terminal apparatus 306 accesses network host 303 using a radio access technique and communicates with an external network via IPAG 305.

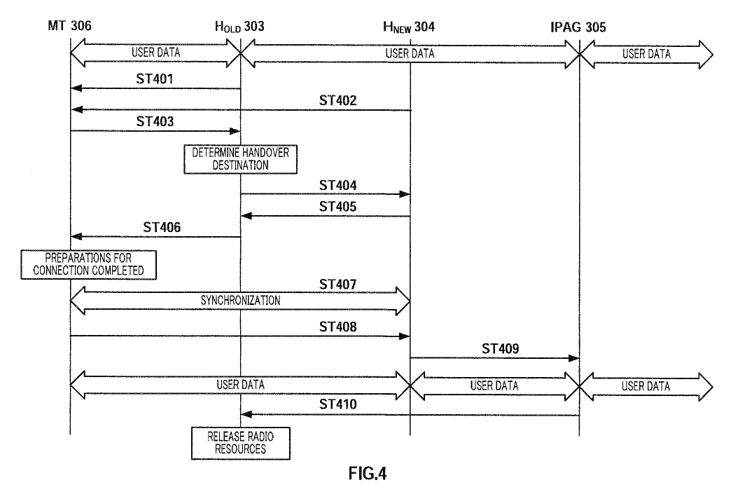

Next, the method communication terminal apparatus 306 performs a handover will be explained using FIG. 4. FIG. 4 is a sequence diagram showing the handover method. In FIG. 4 and explanation of FIG. 4, communication terminal apparatus 306 is “MT,” handover source network host 303 is “H_{OLD}” and handover destination network host 304 is “H_{NEW,}” for ease of explanation. Furthermore, H_{OLD} 303 and H_{NEW} 304 have the same configuration as in FIG. 2.

Suppose MT 306 communicates with external networks via H_{OLD} 303 and IPAG 305. During communication, MT 306 monitors the situation of communication with the surrounding network hosts, in addition to H_{OLD} 303 with which MT 306 is currently connected. More specifically, H_{OLD} 303 and H_{NEW} 304 send CPICH signals (step ST401 and step ST402). Next, MT 306 having received the CPICH signal measures the received power of the CPICH, and reports the measurement result to connected H_{OLD} 303 as a measurement report, which is received quality information (step ST403).

Next, H_{OLD} 303 having received the measurement report decides, based on the measurement result, that it is preferable for MT 306 to perform a handover to H_{NEW} 304 (i.e. handover decision).

H_{OLD} 303 sends a report indicating that H_{NEW} 304 has been selected as the handover destination, that is, sends the handover request of MT 306 with context information, to H_{NEW} 304 (i.e. context transfer request) (step ST404).

Upon receiving the handover request of MT 306 from H_{OLD} 303, H_{NEW} 304 decides whether or not to respond to the request based on the situation radio resources for H_{NEW} 304, and, when deciding to respond to the request, sends a handover response of MT 306 to H_{OLD} 303 (i.e. context transfer reply) (step ST405).

Next, H_{OLD} 303 having received the handover response from H_{NEW} 304 commands MT 306 to perform handover to H_{NEW} 304 (i.e. handover indication) (step ST406). At this moment, MT 306 releases the connection to H_{OLD} 303 and starts a connection to H_{NEW} 304. When the preparation for connection with H_{NEW} 304 is finished (i.e. radio L1 & L2 establishment), MT 306 synchronizes with H_{NEW} 304 (i.e. radio L1 & L2 establishment) (step ST407) and MT 306 also reports the completion of handover to H_{NEW} 304 (i.e. handover complete) (step ST408).

H_{NEW} 304 having received the handover completion report from MT 306 sends a gratuitous ARP message to IPAG 305, to establish a communication channel with IPAG 305 (i.e. relocation request) (step ST409).

Here, “ARP” generally refers to a protocol used to find the physical address of a communicating party apparatus whose IP address is known. The inquiring communication apparatus broadcasts a gratuitous ARP message specifying the IP address of the communicating party apparatus to all communication apparatuses on the network. The communication apparatus corresponding to the specified IP address knows its own physical address and IP address, and sends back a response message, which pairs the physical address and the IP address, to the inquiring communication apparatus. This allows the inquiring communication apparatus to create and update an entry of a pair of a physical address and an IP address. The present embodiment sets the address of IPAG 305 (i.e. unicast address) instead of setting the addresses of all communication apparatuses (i.e. broadcast addresses) in the broadcast field in the gratuitous ARP message, so that the IPAG alone is able to receive the gratuitous ARP message.

Furthermore, the gratuitous ARP is used to report changes of the layer 2 address of a subject apparatus to other apparatuses. That is, gratuitous ARP is used to update the ARP entry of the subject apparatus existing in other network hosts belonging to the same broadcast domain, and is used when, for example, the interface card of layer 2 is changed, to allow other network hosts to quickly update the layer 2 address corresponding to IP address of the subject apparatus.

IPAG 305 having received the gratuitous ARP message stores a pair of the Ethernet address and the IP address stored in Sender Ether addr and Sender IP addr in the gratuitous ARP message, {Ether (H_{NEW}), IP (MT)}, in an ARP cache, and deletes the pair {Ether (H_{OLD}), IP (MT)} stored till then. Through the above described operations, the packet directed to MT 306 received from the external network is transferred to H_{NEW} 304 by IPAG 305 and finally arrives at MT 306.

Next, IPAG 305 commands H_{OLD} 303 of Ethernet Address Ether (H_{OLD}) deleted from the ARP cache, to release the radio resources related to MT 306 (i.e. resource release) (step ST410).

Next, H_{OLD} 303 releases the radio resources related to MT 306 according to commands from IPAG 305 (radio resources release (i.e. release radio bearer resource for MT)).

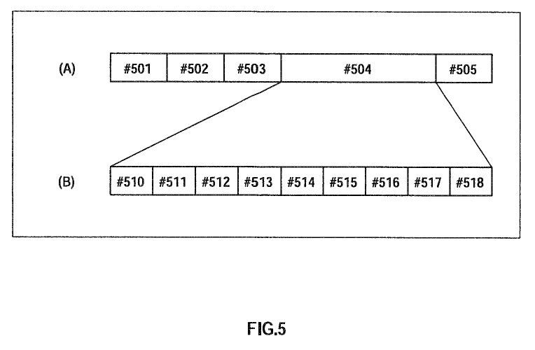

FIG. 5 (A) and FIG. 5 (B) show a format of the gratuitous ARP message. FIG. 5 (A) shows a format of Ethernet data and FIG. 5 (B) shows the format of a gratuitous ARP message included in Ethernet data.

As shown in FIG. 5 (A), Ethernet data is made up of a destination address (Dest Address) field #501 in which a data destination is set, source address (Source Address) field #502 in which the address of a sender is set, ARP identification (Ethernet Type) field #503 in which information for identifying a gratuitous ARP message is set, ARP (ARP Request/Reply) field #504 in which the content of the gratuitous ARP message is set and frame check sequence (FCS) field #505 for checking errors during transmission.

As shown in FIG. 5 (B), gratuitous ARP field #504 is made up of HARD TYPE field #510, PROT TYPE field #511, HARD SIZE field #512, PROT SIZE field #513, OP field #514, sender layer 2 address (“Sender Ether addr”) field #515, sender layer 3 address (“Sender IP addr”) field #516, destination layer 2 address (“Target Ether addr”) field #517 and destination layer 3 address (“Target IP addr”) field #518. OP field #514 is used to make an inquiry when the communicating party apparatus to which a certain IP address is assigned is unknown, and when “1” is set in OP field #514, this indicates that the transmitting side is requesting a response from the communicating party apparatus to which the certain IP address is assigned and when “2” is set in OP field #514, this indicates that a response has been sent from the receiving side.

As for the gratuitous ARP message sent from H_{NEW} 304, H_{NEW} 304 sets an Ethernet address of H_{NEW} 304, which is the layer 2 address of H_{NEW} 304, in sender layer 2 address field #515, sets the IP address of MT 306, which is the layer 3 address of MT 306, in sender layer 3 address field #516, sets the Ethernet address of IPAG 305, which is the layer 2 address of IPAG 305 which is the other party to which a change of the layer 2 address is to be reported, in destination layer 2 address field #517 and sets the Ethernet address of IPAG 305, which is the layer 2 address of IPAG 305 in destination layer 3 address field #518. On the other hand, as for the gratuitous ARP message sent from H_{NEW} 304, H_{NEW} 304 sets the Ethernet address of IPAG 305, which is the layer 2 address of IPAG 305, in destination address field #501 and sets the Ethernet address of H_{NEW} 304, which is the layer 2 address of H_{NEW} 304, in sender address field #502. A broadcast address is set in destination address field #501 in a normal gratuitous ARP message, whereas, with the present embodiment, the Ethernet address of IPAG 305 (unicast address) is set in destination address field #501.

IPAG 305 having received the above described gratuitous ARP message deletes the pair of the Ethernet address of H_{OLD} 303 and the IP address of MT 306 stored in the ARP table of an ARP cache and stores the pair of the Ethernet address of H_{NEW} 304 set in sender layer 2 address field #515 and the IP address of MT 306 set in sender layer 3 address field #516 in the ARP table of the ARP cache. In a cellular system or the like in which a network is constructed in a tree form, this prevents unnecessary traffic from being broadcast over the entire network.

In this way, according to the present embodiment, the handover destination unicasts a message reporting the handover destination address to a higher apparatus and the upper layer apparatus reports a release of connection with the communication terminal apparatus to the handover source, and it is thereby possible to reduce network resources and processing load on network hosts.

### INDUSTRIAL APPLICABILITY

The communication terminal apparatus and handover method according to the present invention are suitable for use in, for example, packet communications using gratuitous ARP in mobile IP technology.

1. A communication apparatus comprising:
a handover control section that decides whether or not a handover to the communication apparatus is possible, upon receiving a report that the communication apparatus has been selected as a handover destination of a communication terminal apparatus and a layer 3 address of the communication terminal apparatus from a communication apparatus of a handover source;
a message creating section that, when the handover is decided possible, creates a message storing the layer 3 address of the communication terminal apparatus and a layer 2 address of the communication apparatus; and
a transmitting section that unicasts the created message to an upper layer apparatus.

2. The communication apparatus according to claim 1, the message creating section creates the message by storing a unicast address of the upper layer apparatus in a field for storing a broadcast address in an gratuitous address resolution protocol message, the gratuitous address resolution protocol message being used to report a change of the layer 2 address of the communication apparatus to other communication apparatuses; and
the transmitting section unicasts the message to the upper layer apparatus at the unicast address.

3. A communication system comprising:
a communication terminal apparatus that reports a measurement result of received quality;
a handover source network host that determines a handover destination based on the measurement result and reports the determination and a layer 3 address of the communication terminal apparatus to the determined handover destination;
a handover destination network host that, upon receiving the report, decides whether or not a handover to the handover destination network host is possible, and that, when the handover is decided possible, unicasts a message storing the layer 3 address and a layer 2 address of the handover destination network host; and
an upper layer apparatus that receives the unicast message, memorizes the layer 2 address stored in the message, sends packet data addressed to the layer 3 address to a handover destination network host of the memorized layer 2 address, and commands the handover source network host of a layer 2 address deleted by the memorization to release the connection with the communication terminal apparatus.

4. A handover method comprising:
reporting, by a communication terminal apparatus, a measurement result of received quality;
determining, by a handover source, a handover destination based on the measurement result;
reporting, by the handover source, the determination and a layer 3 address of the communication terminal apparatus to the handover destination;
deciding, by the handover destination having received the report, whether or not a handover to the handover destination is possible;
when the handover is decided possible, unicasting, by the handover destination, a message storing a layer 3 address and a layer 2 address of the handover destination to an upper layer apparatus;
receiving the message by the upper layer apparatus;
newly memorizing, by the upper layer apparatus, the layer 2 address of the handover destination included in the received message;
commanding, by the upper layer apparatus, the handover source of a layer 2 address deleted by the memorization, to release the connection with the communication terminal apparatus; and
sending, by the upper layer apparatus, packet data directed to the layer 3 address to the handover destination of the layer 2 address.
